(19) United States
(12) Patent Application Publication
(10) Pub. No.: US 2010/0208299 A1
(43) Pub. Date: Aug. 19, 2010

(54) IMAGE FORMING APPARATUS AND IMAGE FORMING SYSTEM

(75) Inventor: Kenji Sakuda, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/705,449

(22) Filed: Feb. 12, 2010

(30) Foreign Application Priority Data
Feb. 13, 2009 (JP) 2009-030830

(51) Int. Cl. G06F 3/12

(52) U.S. Cl. 358/1.15

(57) ABSTRACT

An image forming apparatus includes: a communication unit which carries out communication with a plurality of information processing apparatuses and receives image data from the information processing apparatuses.

### BACKGROUND

1. Technical Field

This application claims the benefit of Japanese Application No. 2009-030830, filed Feb. 13, 2009, the entirety of which is hereby incorporated by reference.

The present invention relates to an image forming apparatus and an image forming system.

2. Related Art

In the past, an improvement in convenience for users was achieved in addition to freedom of connection, compared to wired communication, by connecting plural apparatuses by wireless communication. For example, JP-A-2007-158447 discloses a wireless communication apparatus capable of realizing wireless connection in a user's simple operation by establishing or terminating wireless connection with distance information. The computers of plural users can be connected to one printer to share the printer by using such wireless communication.

When the plural users share one printer, the users can readily find the sheets printed by the users by using a printer having plural discharging trays. In this case, however, when the users select a discharging tray to which the sheets are discharged in printing, a problem may arise in that a complex operation is necessary in every printing. When a correspondence relationship between the discharging trays and the computers of the users is set in advance, a problem may arise in that a complex operation is necessary in order to carry out setting as the number of user computers is numerous. Moreover, a problem may arise in that a complex operation is necessary whenever a user computer is newly added or the correspondence relationship is changed.

### SUMMARY

An advantage of some aspects of the invention is that it provides a technique for readily finding a user's target discharged from an image processing apparatus by a user of an information processing apparatus without a complex operation.

The aspects of the invention are as follows.

According to an aspect of the invention, there is provided an image forming apparatus including: a communication unit which carries out communication with a plurality of information processing apparatuses and receives image data from the information processing apparatuses; an image forming unit which forms an image based on the image data on a target; a distance information acquiring unit which acquires distance information indicating a distance between the image forming apparatus and the information processing apparatus; a plurality of placing members which place the discharged target on which the image is formed by the image forming unit; a discharging unit which discharges the target, on which the image is formed by the image forming unit, to one of the plurality of placing members; a memory unit which stores the plurality of placing members and a plurality of different distance areas in association therewith; and a control unit which controls the image forming unit so that the image based on the image data received from the information processing apparatus is formed on the target and which controls the discharging unit to determine the discharging unit to determine the distance area among the plurality of distance areas which contain the distance expressed as the acquired distance information between the image forming apparatus and the information processing apparatus, to read the placing member corresponding to the determined distance area from the memory unit, and to discharge the target, on which the image is formed, to the placing member.

In the image processing apparatus according to the aspect of the invention, the plurality of placing members, which place the target on which the image based on the image data received from the information processing apparatus is formed, and the plurality of different distance areas are associated with each other to be stored in the memory unit. The image based on the image data received from the information processing apparatus is formed on the target, the distance information indicating the distance between the image forming apparatus and the information processing apparatus is acquired, whether the distance expressed as the distance information between the image forming apparatus and the information processing apparatus is contained among the plurality of distance areas is determined, the placing member corresponding to the determined distance area is read from the memory unit, and the target, on which the image is formed, is discharged to the placing member. In this way, it is possible to readily find the target of the users of the information processing apparatuses without a complex operation executed by selecting the placing member or setting a correspondence relationship between the discharging members and the information processing apparatuses in advance. Moreover, even when an information processing apparatus is newly added or the correspondence relationship between the information processing apparatuses and the placing members is changed, the distance between the information processing apparatus and the image forming apparatus can be contained in the distance area corresponding to a desired placing member without executing a complex operation.

In the image processing apparatus according to the aspect of the invention, the communication unit may carry out wireless communication based on a wireless USB standard with the plurality of information processing apparatuses. When the information processing apparatus and the image forming apparatus carry out the wireless communication, a communication line is not necessary. Therefore, since freedom of the positional relationship between the information processing apparatus and the image forming apparatus is achieved, it is easy to contain the distance between the information processing apparatus and the image forming apparatus in the distance area corresponding to the desired placing member, thereby realizing the aspect of the invention.

In the image processing apparatus according to the aspect of the invention, the distance information acquiring unit may acquire the distance information from the plurality of information processing apparatuses through the communication unit. Alternatively, the image forming apparatus according to the above aspect of the invention may further include a distance measuring unit which measures a distance between the information processing apparatus and the image forming apparatus. The distance information acquiring unit may acquire the distance information from the distance measuring unit. In the former case, the image forming apparatus may have a simple configuration, since it is not necessary for the image forming apparatus to measure the distance. In the latter case, the image forming apparatus according to the aspect of the invention can be easily used even with the information processing apparatus having a simple configuration, since the information processing apparatus can transmit the image data.

According to another aspect of the invention, there is provided a first image forming system including: the image forming apparatus having a configuration in which the above-described distance information acquiring unit acquires the distance information from the plurality of information processing apparatuses through the communication unit; and a plurality of information processing apparatuses which transmit the image data to the image forming apparatus by communication and which measure a distance between the information processing apparatus and the image forming apparatus and transmit the distance information indicating the measured distance to the image forming apparatus to the image forming apparatus by communication.

According to still another aspect of the invention, there is provided a second image forming system including: the image forming apparatus having a configuration other than the configuration in which the above-described distance information acquiring unit acquires the distance information from the plurality of information processing apparatuses through the communication unit; and a plurality of information processing apparatuses which transmit the image data to the image forming apparatus by communication.

The first and second image forming systems according to the aspects of the invention include either of the above-described image forming apparatuses. Accordingly, it is possible to obtain an advantage of readily finding the target of the user of the information processing apparatus without executing a complex operation, for example.

### BRIEF DESCRIPTION OF THE DRAWINGS

The invention will be described with reference to the accompanying drawings, wherein like numbers reference like elements.

FIG. 1 is a diagram illustrating the configuration of a wireless USB system according to an embodiment.

FIG. 2 is an explanatory diagram illustrating an example of a correspondence relationship table.

FIG. 3 is a diagram illustrating the overall configuration of a discharging mechanism.

FIG. 4 is a flowchart illustrating an example of a print processing routine.

FIG. 5 is an explanatory diagram illustrating a screen as an example of a print completion notification screen.

FIG. 6 is a diagram illustrating the configuration of a wireless USB system to which a user PC is added.

FIG. 7 is a diagram illustrating the configuration in which user PCs are connected to a complex apparatus through a wireless LAN.

### DESCRIPTION OF EXEMPLARY EMBODIMENTS

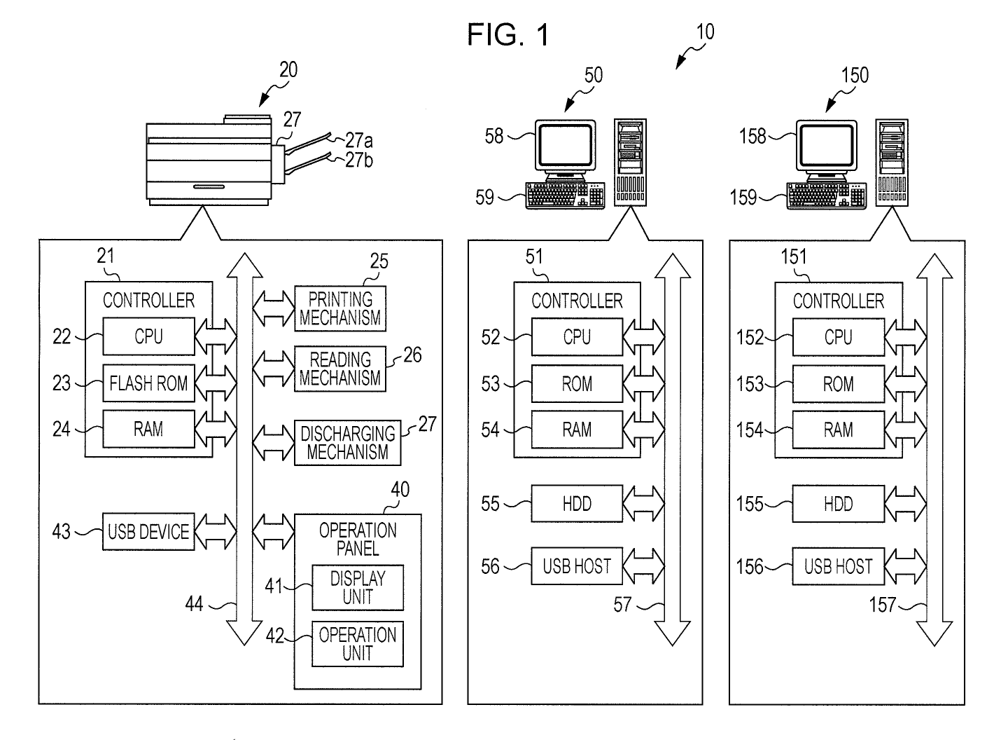

Hereinafter, an embodiment of the invention will be described with reference to the drawings. FIG. 1 is a diagram illustrating the overall configuration of a wireless USB system 10 including a complex apparatus 20 which is an image processing apparatus according to the embodiment of the invention. The wireless USB system 10 includes the complex apparatus 20 printing an image and user personal computers (PCs) 50 and 150 transmitting image data or giving a print instruction to the complex apparatus 20. The complex apparatus 20 and the user PCs 50 and 150 are configured so as to carry out wireless communication by the wireless USB which is a communication standard using wireless communication of UWB (Ultra Wide Band).

The complex apparatus 20 includes: a controller 21 controlling the apparatus as a whole; a printing mechanism 25 printing an image on a print sheet; a reading mechanism 26 reading a document placed on a glass surface (not shown) of the complex apparatus 20; a discharging mechanism 27 discharging a print sheet to a first discharging tray 27a or a second discharging tray 27b; an operation panel 40 capable of displaying information for a user and receiving an input of an instruction of the user; and a USB device 43 capable of carrying out wireless communication with an external apparatus (for example, the user PCs 50 and 150). In addition, the controller 21 is connected to the printing mechanism 25, the reading mechanism 26, the discharging mechanism 27, the operation panel 40, and the USB device 43 via a bus 44.

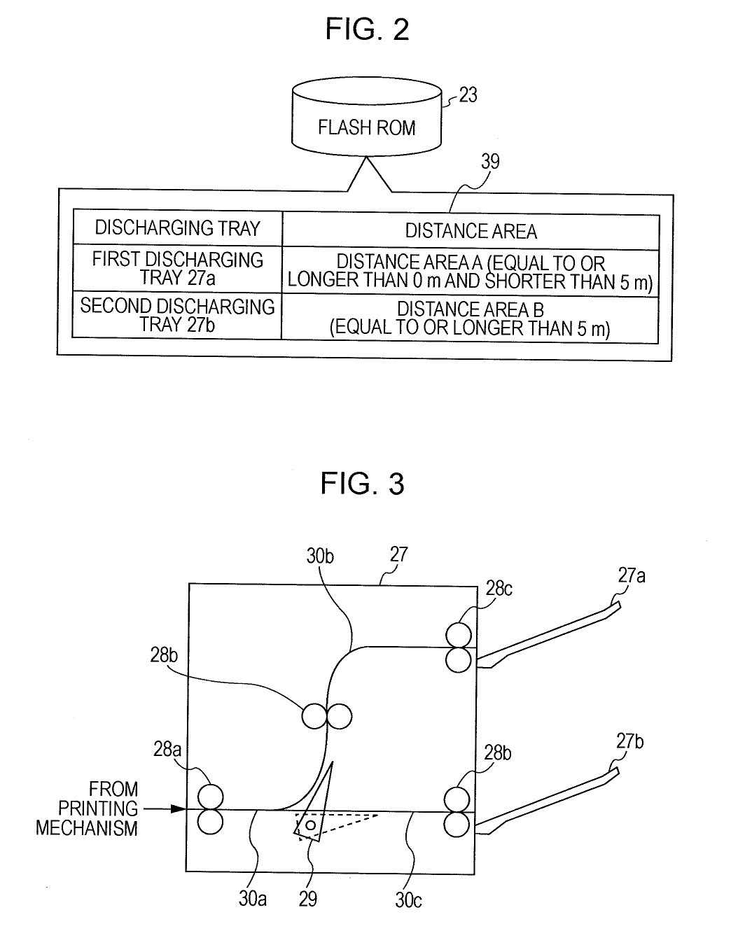

The controller 21 is configured as a microprocessor with a CPU 22 and includes a flash ROM 23 storing and rewriting various processing programs or various setting values as memorable information and a RAM 24 temporarily storing data. In addition, the flash ROM 23 stores a correspondence relationship table 39 used in a print processing routine described below. In the correspondence relationship table 39, the first discharging tray 27a and the second discharging tray 27b are associated with distance areas, as shown in FIG. 2. In this embodiment, the first discharging tray 27a is associated with distance area A (an area equal to or longer than 0 m and shorter than 5 m) and the second discharging tray 27b is associated with distance area B (an area equal to or longer than 5 m).

The printing mechanism 25 includes ink cartridges storing cyan (C) ink, magenta (M) ink, yellow (Y) ink, and black (K) ink, respectively, even though not shown. The printing mechanism 25 is an ink jet printing mechanism which prints an image on a print sheet on the basis of image data by pressurizing each ink supplied from each ink cartridge and ejecting the pressurized ink to the print sheet. The mechanism may be a mechanism capable of pressurizing ink through the deformation of piezoelectric elements or a mechanism capable of generating bubbles through the heat of a heater.

The reading mechanism 26 is configured as a known full-color scanning mechanism capable of reading a document placed on the glass surface (not shown) as image data. The reading mechanism 26 includes a known color image sensor capable of decomposing light emitted toward the document and reflected from the document into colors of red (R), green (G), and blue (B) and setting the decomposed light to reading data.

The discharging mechanism 27 is a mechanism which discharges the print sheet, on which an image is printed by the printing mechanism 25, to the first discharging tray 27a or the second discharging tray 27b. The overall configuration of the discharging mechanism 27 is shown in FIG. 3. As shown in FIG. 3, the discharging mechanism 27 includes: a transport passage 30a along which a print sheet printed by the printing mechanism 25 initially passes inside the discharging mechanism 27; a transport roller 28a transporting the print sheet along the transport passage 30a; transport passages 30b and 30c along which the print sheet is discharged to the first discharging tray 27a and the second discharging tray 27b, respectively; transport rollers 28b and 28c transporting the print sheet along the transport passage 30b; a transport roller 28d transporting the print sheet along the transport passage 30c; and a flapper 29 sending the print sheet passing though the transport passage 30a to the transport passage 30b or 30c in accordance with a control signal from the CPU 22. The flapper 29 is a mechanism operated by a motor (not shown) driven by the control signal from the CPU 22. When the flapper 29 is located at the position indicated by a solid line in the drawing, the print sheet passes along the transport passages 30a and 30b to be discharged to the first discharging tray 27a. When the flapper 29 is located at the position indicated by a dash line, the print sheet passes along the transport passages 30a and 30c to be discharged to the second discharging tray 27b.

The operation panel 40 is a device which displays various kinds of information for a user and to which the user inputs various instructions to the complex apparatus 20. The operation panel 40 includes a display unit 41 displaying characters or images in response to various instructions and an operation unit 42 receiving the input of an instruction of the user by various buttons.

The USB device 43 is a device capable of transmitting or receiving information in a wireless communication way by the wireless USB and capable of transmitting or receiving information to or from USB hosts 56 and 156 of the user PCs 50 and 150. The USB hosts are described below.

the user PC 50 is a known general PC includes: a controller 51 having a CPU 52 executing various kinds of control, a ROM 53 storing various control programs, and a RAM 54 temporarily storing data; an HDD 55 which is a large-capacity memory storing various application programs or various data files; and the USB host 56 transmitting or receiving data to and from an external apparatus (for example, the complex apparatus 20) in a wireless way. The controller 51 is connected to the HDD 55 and the USB host 56 via a bus 57. The user PC 50 includes a display unit 58 displaying various kinds of information and an input device 59 such as a keyboard with which a user inputs various instructions. The user PC 50 gives an instruction to print an image to the complex apparatus 20 on the basis of the image data by an installed program.

The user PC 150 includes the same units as those of the user PC 50. Therefore, the reference numerals of the units of the user PC 150 are obtained by adding 100 to the reference numerals of the user PC 50, and the description is omitted. It is assumed that the user PC 50 is located at the position distant from the complex apparatus 20 by 3 m and the user PC 150 is located at the position distant from the complex apparatus 20 by 7 m.

Hereinafter, the wireless communication by the wireless USB will be described. By the wireless USB, wireless communication is carried out between hosts (in this embodiment, the USB hosts 56 and 156) and a device (in this embodiment, the USB device 43). In order to carry out the wireless communication by the wireless USB, first, the hosts and the device beforehand have to share connection context information (hereinafter, referred to as CC information) corresponding to a communication destination. The CC information contains information necessary for communication, such as an ID unique in the host or the device carrying out communication and a connection key. Examples of a way of sharing the CC information include a USB cable way (Out-of-Band way) of sharing the CC information by establishing connection one another by a USB cable and a numeric way (In-Band way) of sharing the CC information in wireless communication by the UWB. Secure communication can be initiated by confirming that the host and device sharing the CC information share the same connection key by 4-way handshake and by establishing the connection between the host and the device. In this embodiment, it is assumed that the USB hosts 56 and 156 completely share the CC information with the USB device 43 in advance.

Hereinafter, the operation of the wireless SUB system 10 having the above-described configuration according to this embodiment will be described. In particular, the operation performed when the user PCs 50 and 150 give a print instruction to the complex apparatus 20 will be described.

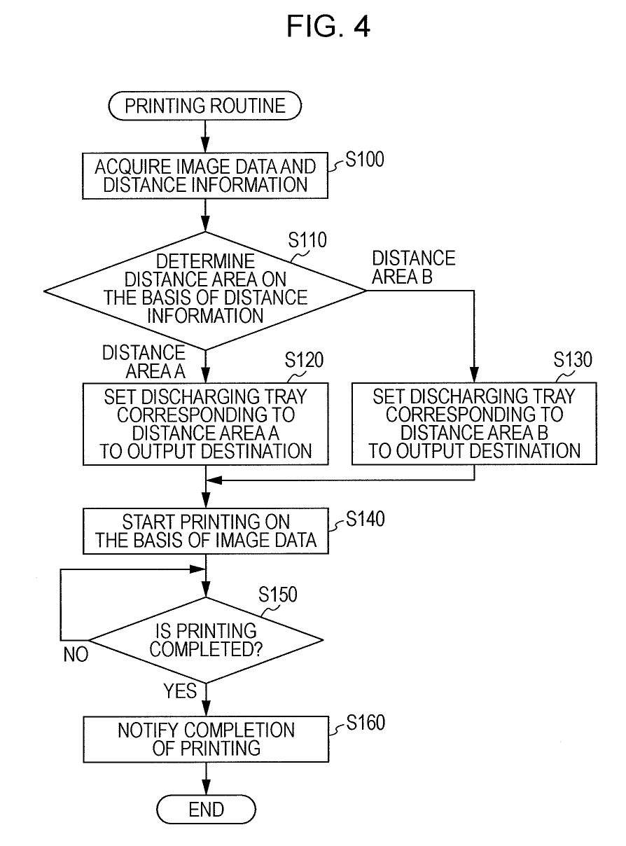

FIG. 4 is a flowchart illustrating an example of a print processing routine. The print processing routine is executed by the CPU 22, when the user PC 50 or the user PC 150 is connected to the complex apparatus 20 by the wireless USB and the USB device 43 of the complex apparatus 20 receives a print request from the user PC 50 or the user PC 150. Hereinafter, a case where the print request is received from the user PC 50 will be described.

When the print processing routine is executed, the CPU 22 first acquire image data and distance information contained in a print request received from the user PC 50 through the USB device 43 (step S100). The print request contains the image data used to execute printing and the distance information indicating a distance between the complex apparatus and the user PC 50 transmitting the print request to the complex apparatus 20. When the user designates the image data or the like stored in the HDD 55, for example, through the input device 59 and instructs the printing, the CPU 52 of the user PC 50 transmits the print request containing the designated image data and the distance information to the complex apparatus 20 through the USB host 56. Here, the distance information can be calculated using a location measuring function of the wireless communication scheme UWB used in the wireless USB. In this embodiment, the distance information is calculated on the basis of a time measured such that the USB host 56 transmits a signal and then receives a signal transmitted as the reply by the USB device 43. As a specific calculating method, for example, the distance information may be calculated by a product of a propagation rate of the signal and a time until the reception of the signal. Alternatively, a relationship between a time and a distance until the signal is received in advance is stored as a map in the ROM 53 and a distance is calculated using the map and a time until the reception of the signal. The USB host 56 transmits a signal at a predetermined time interval (for example, several hundreds of ms). Therefore, the CPU 52 calculates the distance information and stores the newest value in a distance information storing buffer of the RAM 54, whenever receiving the signal from the USB device 43. In this embodiment, since a distance between the user PC 50 and the complex apparatus 20 is 3 m, as described above, a value of 3 m is stored as the distance information.

When the image data and the distance information are acquired in step S100, the CPU 22 determines whether a distance expressed as the acquired distance information is contained in distance area A or distance area B of the correspondence relationship table 39 stored in the flash ROM 23 (step S110). When it is determined that the distance expressed as the distance information is contained in distance area A, the first discharging tray 27a serving as a discharging tray corresponding to distance area A of the correspondence relationship table 39 is set as the output destination of the print sheet subjected to the printing (step S120). Alternatively, when it is determined that the distance expressed as the distance information is contained in distance area B, the second discharging tray 27b serving as a discharging tray corresponding to distance area B of the correspondence relationship table 39 is set as the output destination of the print sheet subjected to the printing (step S130). Specifically, the setting of the output destination of the print sheet is executed in such a manner that the CPU 22 transmits a control signal to the discharging mechanism 27, activates the motor, and adjusts the position of the flapper 29. Since the distance information acquired in step S100 is 3 in the state where the print request is received from the user PC 50, the distance of 3 m expressed as the distance information is determined to be contained in distance area A in step S110. Therefore, in step S120, the control signal is transmitted to the discharging mechanism 27 to operate the motor so that the flapper 29 is located at the position indicated by the solid line in FIG. 2. In this way, the print sheet printed by the printing mechanism 25 is discharged from the discharging mechanism 27 via the transport passages 30a and 30b to be placed in the first discharging tray 27a.

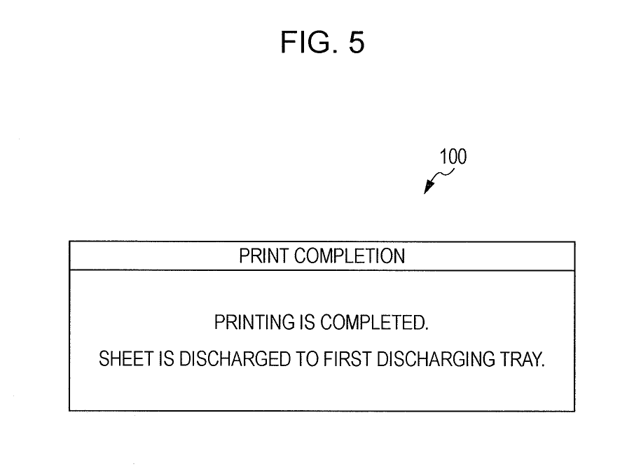

When the process of step S120 or S130 is executed, the CPU 22 controls the printing mechanism 25 via the bus 44 to start printing an image on the print sheet on the basis of the image data acquired in step S100 (step S140) and waits until the printing mechanism 25 completes the printing (step S150). Subsequently, when the printing is completed, a print completion notice containing a message indicating the completion of the printing and information regarding the output destination of the print sheet is transmitted through the USB device 43 (step S160), and then this routine ends. Since the discharge destination of the print sheet is set to the first discharging tray 27a in the state where the print request is received from the user PC 50, a print completion notice containing a message indicating the completion of the printing and a message indicating the discharge completion of the print sheet to the first discharging tray 27a is transmitted to the user PC 50. In addition, when the CPU 52 of the user PC 50 receives the above print completion notice from the complex apparatus 20 through the USB host 56, for example, a print completion notice screen containing a message indicating the print completion and a message indicating the discharge completion of the print sheet to the first discharging tray 27a, as in a screen 100 of FIG. 5, is displayed on the display unit 58 to notify the print completion to the user.

On the other hand, when a print request is received from the user PC 150, it is determined in step S110 that the distance of 7 m expressed as the distance information is contained in distance area B, since the value of the distance information acquired in step S100 is 7. Then, the process proceeds to step S130 and the second discharging tray 27b corresponding to distance area B in the correspondence relationship table 39 is set to the discharge destination. That is, the control signal is transmitted to the discharging mechanism 27 to activate the motor so that the flapper 29 is located at the position indicated by the dash line in FIG. 2. In this way, the print sheet printed by the printing mechanism 25 is discharged from the discharging mechanism 27 via the transport passages 30a and 30c to be placed in the second discharging tray 27b. Subsequently, the process proceeds to step S140. The printing mechanism 25 is controlled via the bus 44 to print an image based on the acquired image data on the print sheet and it is waited until the printing mechanism 25 completes the printing in step S150. When the printing is completed, a print completion notice containing a message indicating the print completion via the USB device 43 and a message indicating the discharge completion of the print sheet to the second discharging tray 27b is transmitted in step S160, and then this routine ends. In addition, when the CPU 152 of the user PC 150 receives the above print completion notice from the complex apparatus 20 through the USB host 156 like the user PC 50, a print completion notice screen containing a message indicating the print completion and a message indicating the discharge completion of the print sheet to the second discharging tray 27b is displayed on the display unit 158 to notify the print completion to the user.

Here, the constituent elements according to this embodiment correspond to constituent elements according to the invention as follows. The user PCs 50 and 150 according to this embodiment correspond to an information processing apparatus according to the invention. The USB device 43 corresponds to a communication unit. The printing mechanism 25 corresponds to an image forming unit. The CPU 22 corresponds to a distance information acquiring unit and a controller. The first discharging tray 27a and the second discharging tray 27b correspond to a placing member. The discharging mechanism 27 corresponds to a discharging unit. The flash ROM 23 corresponds to a memory unit. The complex apparatus 20 corresponds to an image forming apparatus. The wireless USB system 10 corresponds to an image forming system. In this embodiment, an example of the image forming system according to the invention is apparent from the description of the operation of the wireless USB system 10 including the complex apparatus 20.

According to the above-described embodiment, an image based on the image data received from the user PCs 50 or 150 is printed on the print sheet, the distance information indicating the distance between the user PC transmitting the image data and the complex apparatus 20 is acquired to determine whether the distance expressed as the distance information is contained in distance area A or distance area B stored in the flash memory ROM 23, the discharging tray corresponding to the determined distance area is read from the flash ROM 23 to set the discharge destination of the print sheet, and then the printed print sheet is discharged to the discharging tray determined as the discharge destination by the discharging mechanism 27. In this way, the user of the user PC 50 and the user of the user PC 150 can find the printing product of the user without a complex operation executed such that the user of the user PC 50 and the user of the user PC 150 select the discharging tray or a correspondence relationship between the first discharging tray 27a and the second discharging tray 27b and the user PCs 50 and 150 is set in advance. Moreover, since it is not necessary for the complex apparatus 20 to measure the distance, it is possible to realize the simple configuration of the complex apparatus 20.

The invention is not limited to the above-described embodiment, but may be modified in various forms within the technical scope of the invention.

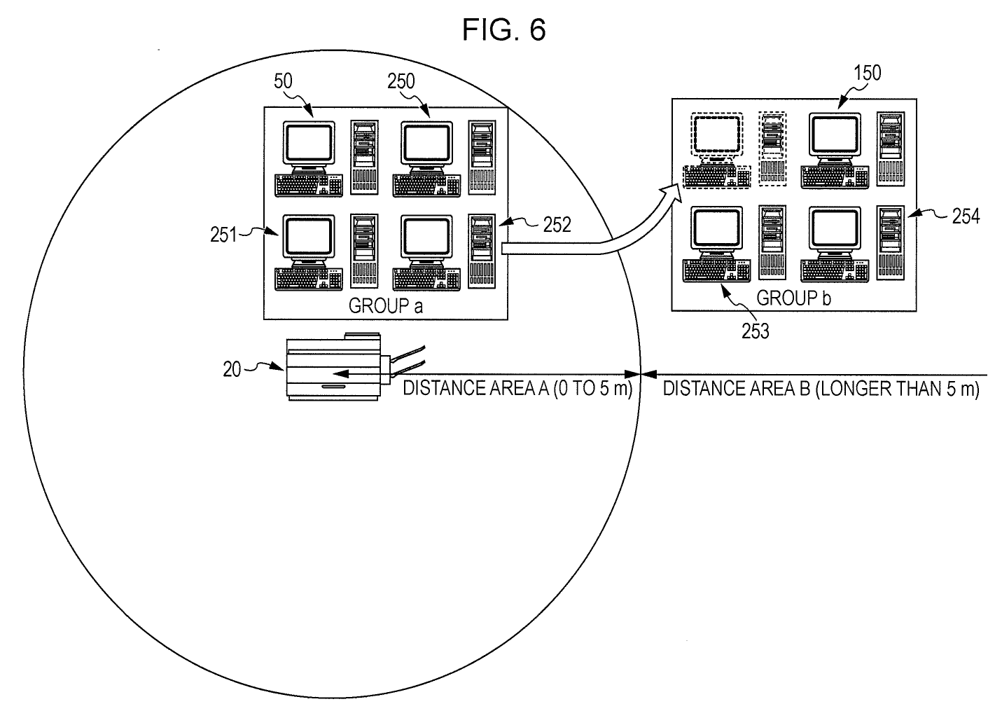

For example, in the above-described embodiment, the wireless USB system 10 includes the user PCs 50 and 150. However, the wireless USB system 10 may include three or more user PCs. FIG. 6 is a diagram illustrating the configuration of the less USB system 10 to which user PCs 250 to 254 are newly added. Since the user PCs 250 to 254 have the same constituent elements as those of the user PCs 50 and 150, it is assumed that the CC information is shared in advance between the USB hosts of the user PCs 250 to 254 and the USB device 43. The user PCs 50 and the user PCs 250 to 252 belong to group a executing a predetermined information process and the user PCs 150, 253, and 254 belong to group b executing information process different from that of group a. As shown in FIG. 6, the user PCs 250 to 252 are disposed so as to be contained in distance area A and the user PCs 253 and 254 are disposed so as to be contained in distance area B. Therefore, when the USB device 43 of the complex apparatus 20 receives a print request from the user PCs 250 to 252, the above-described print processing routine is executed by the CPU 22 and the print sheet subjected to the printing is discharged to the first discharging tray 27a. Similarly, when the USB device 43 of the complex apparatus 20 receives a print request from the user PCs 253 and 254, the print sheet subjected to the printing is discharged to the second discharging tray 27b. That is, when a user PC is newly added, the discharging tray to which the print sheet is discharged in accordance with the distance between the user PC and the complex apparatus 20 is automatically determined. Accordingly, it is not necessary to execute a complex operation of setting the correspondence relationship between the user PC and the discharging tray in advance. In general, when there are several groups of the user PCs carrying out the same information process or the same work, it is preferable to use a different discharging tray in each of the groups. As in FIG. 6, when the user PCs are arranged in advance or the correspondence relationship table 39 is set so that the user PCs of the same group are contained in the same distance area, a different discharging tray can be used without executing a complex operation of individually setting the correspondence relationship between the PCs and the discharging tray. When the group of the user PCs is changed and thus the correspondence relationship between the user PCs and the discharging tray is desired to be changed, it is preferable that the arrangement of the user PCs is changed so that the user PCs are contained in the same distance area as that of the changed group. For example, when the location of the user PC 252 is changed so as to belong to group b, the user PC 252 is arranged at the position (for example, the position indicated by a dash line in FIG. 6) contained in distance area B. Then, the print sheet can be discharged to the second discharging tray 27b as in the other user PCs belonging to group b. In general, the user PCs belonging to the same group are arranged relatively closely in many cases. Therefore, when the group of the user PC is changed, the position of the user PC is changed to the position relatively near the user PC of the changed group. Accordingly, the discharge destination of the print sheet can automatically be changed to the discharging tray used by the changed group.

In the above-described embodiment, the CPUs 52 and 152 calculate the distance information by using the location measuring function of the wireless communication method UWB used in the wireless USB. However, the distance information may be calculated by another method. For example, the user PCs 50 and 150 may have a device capable of measuring the distance with the complex apparatus 20. Alternatively, the complex apparatus 20 may serve as a device calculating the distance information. In this case, the distance information may be calculated on the basis of a time measured by transmitting a signal from the USB device 43 and receiving a reply for the signal by the USB host 56 and 156, as in the above-described embodiment. Alternatively, a separate device measuring the distance between the user PCs 50 and 150 may be provided. In this way, when the complex apparatus 20 calculates the distance information, the user PCs 50 and 150 may transmit the image data to the complex apparatus 20 even in a case where the user PCs 50 and 150 may not calculate and transmit the distance information. Accordingly, the user PC having a simple configuration may also use the complex apparatus 20.

In the above-described embodiment, the wireless communication conforming with the communication standard of the wireless USB is carried out between the complex apparatus 20 and the user PCs 50 and 150. However, the wireless communication may be carried out by another standard. Alternatively, the complex apparatus 20 and the user PCs 50 and 150 may be connected to each other through a communication line to carry out wired communication.

In the above-described embodiment, the complex apparatus 20 include two discharging trays, that is, the first discharging tray 27a and the second discharging tray 27b. However, the complex apparatus 20 may include three or more discharging trays. In this case, in the correspondence relationship table 39, the distance areas may be associated with all of the discharging trays. Alternatively, the discharging tray which is not associated with the distance area may be used. For example, the discharging tray may discharge the print sheet only when the user of the user PC selects the discharging tray. The discharging tray may discharge the print sheet only when the CPU 22 acquires distance information which does not belong to any distance area of the correspondence relationship table 39. In the correspondence relationship table 39, the plural discharging trays may be associated with any of two different distance areas. For example, two discharging trays among three discharging trays may be associated with distance area A and one discharging tray may be associated with distance area B. In this case, when a print request is received from the user PC contained in distance area A, the print sheets may be discharged alternately to two discharging trays corresponding to distance area A in every print request.

In the above-described embodiment, two distance areas, that is, distance area A and distance area B are used, but the invention is not limited thereto. Other distance areas may be used. Three or more different distance areas may be used. For example, a non-continuous distance area “equal to or shorter 3 m or longer than 6 m” may be used. The distance area of the correspondence relationship table 39 may be set with an arbitrary value by the user.

In the above-described embodiment, the discharging mechanism 27 changes the transport passage of the print sheet by the flapper 29. However, any configuration may be used as long as the print sheet on which an image is printed by the printing mechanism is discharged to any discharging tray of the plural discharging trays. For example, only one passage is used, but the plural discharging trays may be moved vertically to discharge the print sheet to several discharging trays.

In the above-described embodiment, the USB device 43 carries out communication with the USB hosts 56 and 156. However, the complex apparatus 20 may include plural USB devices and one USB device may carry out communication predetermined one USB host.

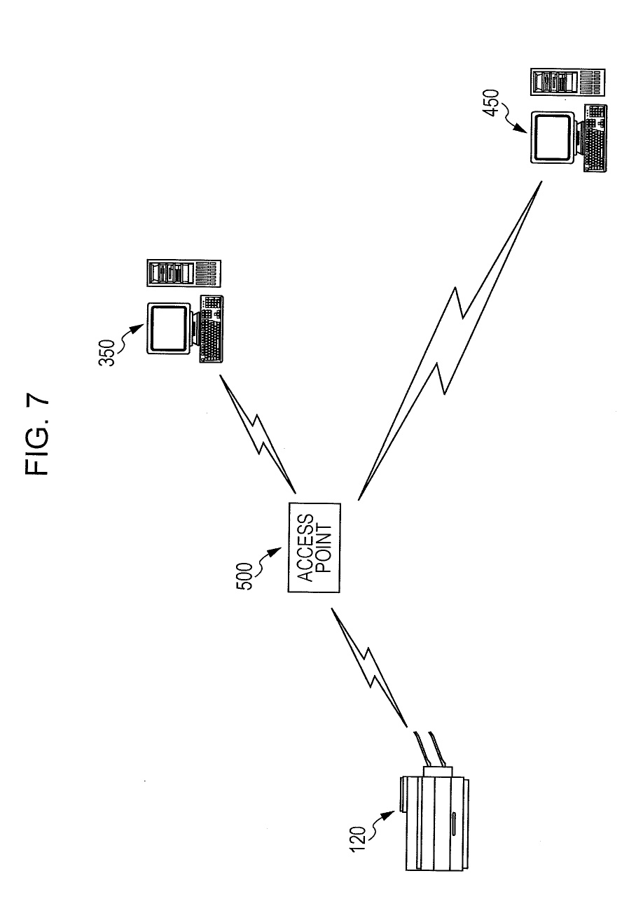

In the above-described embodiment, the complex apparatus 20 and the user PCs 50 and 150 are directly connected by the wireless USB to carry out communication. However, the communication may be carried out via a relay point such as an access point of a wireless LAN, for example. FIG. 7 is a diagram illustrating a configuration in which user PCs 350, 450 and a complex apparatus 120 are connected to each other via an access point 500 by a wireless LAN. In this case, the user PC 350, the user PC 450, or the access point 500 may calculate the distance between the user PCs 350 and 450 and the access point 500 and may transmit the distance as the distance information to the complex apparatus 120. A distance obtained by adding the distance between the user PC 350 and the access point 500 and the distance between the access point 500 and the complex apparatus 120 may be set as the distance information. That is, the distance of the communication path between the user PC 350 or 450 and the complex apparatus 120 may be set as the distance information. In this case, the distance of the communication path may be calculated in such a manner that the user PC 350, the user PC 450, or the access point 500 calculates the distance between the user PC 350 or 450 and the access point 500 and the complex apparatus 120 or the access point 500 calculates the distance between the complex apparatus 120 and the access pint 500 and then these distances are added. Alternatively, the complex apparatus 120 may calculate a straight distance between the user PCs 350 and 450 and may set the straight distance as the distance information. The straight line may be calculated in such a manner that the access point 500, for example, calculates the distance and direction with the user PC 350 and the distance and direction with the complex 120, and the distance between the user PC 350 and the complex apparatus 120 is calculated by the remaining one side of a triangle formed by the apex of the user PC 350, the access point 500, and the complex apparatus 120. The direction of the user PC 350 with respect to the access point 500 may be calculated by a trigonometrically method using a time difference until the same signal is received from the user PC 350 and a signal propagation rate in a state where the access point 500 include three receivers, for example. The direction of the complex apparatus 120 with respect to the access point 500 may be calculated by the same method.

In the above-described embodiment, in step S160 of the print processing routine, the print completion notice containing the message indicating the print completion and the information regarding the discharge destination of the print sheet is transmitted to the user PCs. However, the information regarding the discharge destination of the print sheet may not be contained. In this case, in the user PC, a message indicating to which discharging tray the print sheet is discharged may not be notified to the user, but the user may beforehand grasp the correspondence relationship stored in the correspondence relationship table 39 or the user may initially transmit the print request to memorize the discharging tray used when the print processing routine is executed. The user PC may transmit the distance information to the complex apparatus 20 when the user PC is initially connected to the complex apparatus 20. The CPU 22 may determine the distance area as in step S110 of the print processing routine, may notify the discharging tray corresponding to the determined distance area to the user PC, and may beforehand notify the user of the discharging tray to which the print sheet is discharged. The user PC may beforehand store the same table as the correspondence relationship table 39 in a memory medium such as a ROM or an HDD. Then, the CPU of the user PC may execute the determination of step S110 of the above-described print processing routine by using the distance information stored in the distance information storing buffer of the RAM and the stored table and may notify the user of the discharging tray corresponding to the determined distance area.

In the above-described embodiment, the user PCs 50 and 150 serving as the known general PC transmit the image data to the complex apparatus 20 to execute the printing. However, any information processing apparatus may be used as well s the user PCs, as long as the image data can be transmitted to the complex apparatus 20. For example, a portable mobile PC or an information digital camera may be used.

In the above-described embodiment, the complex apparatus 20 including the printing mechanism 25 has been realized as a specific example of the image forming apparatus according to the invention. However, a fluid ejecting apparatus ejecting a liquid-formed substance (dispersion liquid) in which particles of another liquid other than ink or a functional material are dispersed or ejecting a fluid-formed substance such as gel may be realized as the image forming apparatus. A fluid ejecting apparatus ejecting a solid material ejected as a fluid may be realized as the image forming apparatus. Examples of the image forming apparatus include: a liquid ejecting apparatus ejecting a liquid in which a material such as an electrode material or a coloring material used to manufacture a liquid display device, an EL (electroluminescence) display, and a plane emission display is dissolved; a liquid-formed substance ejecting apparatus ejecting a liquid-formed substance in which the material such as an electrode material or a coloring material is dispersed; and a liquid ejecting apparatus ejecting a liquid used as a sample used by a precise pipette; a liquid ejecting apparatus ejecting a transparent resin liquid such as a UV curable resin onto a substrate so as to form a minute semispherical lens (optical lens) used for a communication element; a liquid ejecting apparatus ejecting an etching liquid such as acid or alkali to etch a substrate or the like; a liquid-formed substance ejecting apparatus ejecting gel; and a fine particle ejection type recording apparatus ejecting a solid such as a fine particle such as toner may be used.

What is claimed is:

1. An image forming apparatus comprising:
a communication unit which carries out communication with a plurality of information processing apparatuses and receives image data from the information processing apparatuses;
an image forming unit which forms an image based on the image data on a target;
a distance information acquiring unit which acquires distance information indicating a distance between the image forming apparatus and the information processing apparatus;
a plurality of placing members which place the discharged target on which the image is formed by the image forming unit;
a discharging unit which discharges the target, on which the image is formed by the image forming unit, to one of the plurality of placing members;
a memory unit which stores the plurality of placing members and a plurality of different distance areas in association therewith; and
a control unit which controls the image forming unit so that the image based on the image data received from the information processing apparatus is formed on the target and which controls the discharging unit to determine the discharging unit to determine the distance area among the plurality of distance areas which contain the distance expressed as the acquired distance information between the image forming apparatus and the information processing apparatus, to read the placing member corresponding to the determined distance area from the memory unit, and to discharge the target, on which the image is formed, to the placing member.

2. The image forming apparatus according to claim 1, wherein the communication unit carries out wireless communication based on a wireless USB standard with the plurality of information processing apparatuses.

3. The image forming apparatus according to claim 1, wherein the distance information acquiring unit acquires the distance information from the plurality of information processing apparatuses through the communication unit.

4. The image forming apparatus according to claim 1, further comprising:
a distance measuring unit which measures a distance between the information processing apparatus and the image forming apparatus,
wherein the distance information acquiring unit acquires the distance information from the distance measuring unit.

5. An image forming system comprising:
the image forming apparatus according to claim 3; and
a plurality of information processing apparatuses which transmit the image data to the image forming apparatus by communication and which measure a distance between the information processing apparatus and the image forming apparatus and transmit the distance information indicating the measured distance to the image forming apparatus to the image forming apparatus by communication.

6. An image forming system comprising:
the image forming apparatus according to any one of claims 1, and
a plurality of information processing apparatuses which transmit the image data to the image forming apparatus by communication.
